(19) United States
(12) Patent Application Publication
(10) Pub. No.: US 2015/0317608 A1
(43) Pub. Date: Nov. 5, 2015

(54) JOB RECRUITER AND JOB APPLICANT CONNECTOR

(71) Applicant: LinkedIn Corporation, Mountain View, CA (US)

(72) Inventors: Vaibhav Goel, Mountain View, CA (US); Trevor Walker, San Francisco, CA (US)

(21) Appl. No.: 14/297,353

(22) Filed: Jun. 5, 2014

Related U.S. Application Data
(60) Provisional application No. 61/986,420, filed on Apr. 30, 2014.

(51) Int. Cl. G06Q 10/10; G06Q 50/00

(52) U.S. Cl. CPC G06Q 10/1053; G06Q 50/01

(57) ABSTRACT

A system maintains member profiles and job postings on a social networking service, a business networking service, or a job posting service. The system displays a member profile to a job recruiter or a job posting to a job candidate. The system receives from the job recruiter an indication of an interest in the job candidate, and receives from the job candidate an indication of an interest in the job posting. After receiving both the interest of the recruiter and the interest of the member, the system transmits a message to the recruiter informing the recruiter of the interest of the job candidate and transmits a message to the job candidate informing the job candidate of the interest of the recruiter.

### TECHNICAL FIELD

The subject matter disclosed herein generally relates to a system and method for establishing a connection between a job applicant and a job recruiter.

### BACKGROUND

Job postings to advertise an available job and solicit applications for the job are well known. Specifically, job postings have been incorporated into newspapers, periodicals, and the like for many years. More recently however, search engines and websites facilitating job searching have presented job openings electronically. In such circumstances, entities advertising jobs conventionally pay a fee to the owner of the platform on which the advertisement is to be displayed. As a result, advertisements may be displayed generally to most if not all of the users who access the platform.

Job recruiters who search out qualified job applicants for particular companies or particular jobs have also been in existence for many years. Job recruiters can be an employee of the company that is searching for job candidates, or such recruiters can be independent consultants who work on a contract basis with a company that is searching for job candidates to fill particular job openings in the company. Job recruiters historically have used simple telephone contacts and referrals in their search for job candidates. More recently however, job recruiters, like job applicants themselves, have used websites and search engines to facilitate their search for the best candidates.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server.

FIG. 3 is a block diagram showing some of the functional components or modules that comprise a connection engine.

FIGS. 4A and 4B are example user interfaces that can be displayed on a recruiter user device.

FIGS. 5A and 5B are example user interfaces that can be displayed on a job candidate user device.

FIGS. 6A and 6B are a block diagram illustrating features and operations of a process and system for connecting job recruiters and job applicants.

FIG. 7 is a block diagram illustrating components of a machine able to read instructions from a machine-readable medium.

### DETAILED DESCRIPTION

Example methods and systems are directed to connecting job candidates and job recruiters. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

While broad dissemination of a job posting may be desirable for both the job candidate and the job recruiter, it still may be difficult for a job recruiter to connect with job candidates who are a particular good match for the posted job, and it may still be difficult for a job candidate to connect with a job recruiter who has a specific interest in the job candidate. Consequently, a system has been developed that establishes a connection between a job recruiter and a job candidate after, and only after, both of the following have occurred—the job recruiter has indicated an interest in the job candidate and the job candidate has indicated an interest in the posted job that is associated with the job recruiter.

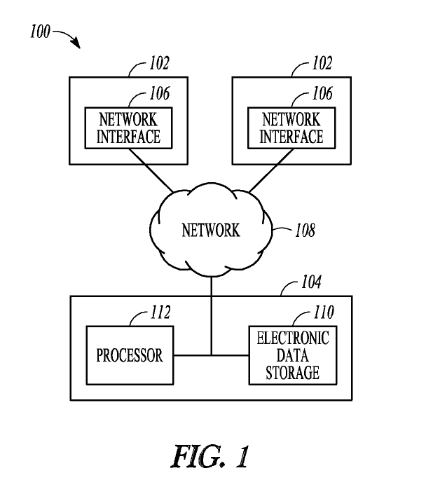

FIG. 1 is a block diagram of a system 100 including user devices 102 and a social network server, business network server, or job posting server 104. User devices 102 can be a personal computer, netbook, electronic notebook, smartphone, or any electronic device known in the art that is configured to display web pages. The user devices 102 can include a network interface 106 that is communicatively coupled to a network 108, such as the Internet.

The social network server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The social network server 104 can store information in the electronic data storage device 110 related to users and/or members of the social network, such as in the form of user characteristics corresponding to individual users of the social network. For instance, for an individual user, the user's characteristics can include one or more profile data points, including, for instance, name, age, gender, profession, prior work history or experience, educational achievement, location, citizenship status, leisure activities, likes and dislikes, and so forth. The user's characteristics can further include behavior or activities within and without the social network, as well as the user's social graph. For an organization, such as a company, the information can include name, offered products for sale, available job postings, organizational interests, forthcoming activities, and the like.

The social network server 104 can further store information in the electronic data storage device 110 related to job postings. For instance, for a particular job posting, the job posting can include a company name, job title, job location, number of years prior experience required, education requirements, residency or immigration status, salary, and skill requirements.

The ability to connect a job recruiter and a job candidate in real-time or essentially real-time can be implemented with a general connection engine. Accordingly, at least in some examples, the connection engine provides a connection service for job recruiters and job candidates. While the general connection engine may operate in real time, it may also execute as a background operation, such as offline or as part of a batch process. In some examples that incorporate relatively large amounts of data to be processed, such as when there are a multitude of job recruiters and a multitude of job candidates, the general connection engine may execute via a parallel or distributed computing platform.

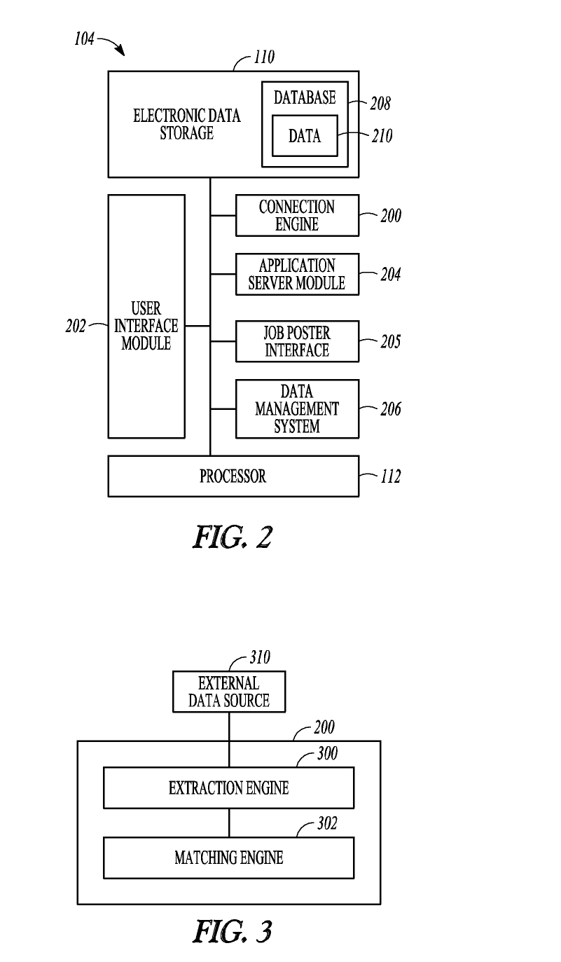

FIG. 2 is a block diagram illustrating various components of a social networking server 104 with a connection engine 200 for matching and connecting a job recruiter who has exhibited an interest in a particular job candidate and a job candidate who has also exhibited an interest in the particular job posting associated with the job recruiter. In an example, the social networking server 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module (e.g., a web server) 202, which receives requests from various client computing devices (e.g., job recruiter devices and job candidate devices), and communicates appropriate responses to the requesting client devices (e.g., a connection between recruiter and candidate after both have exhibited an interest). For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 202, generate various user interfaces (e.g., web pages) with data retrieved from various data sources in the data layer. With some embodiments, individual application server modules 204 are used to implement the functionality associated with various services and features of the system 100. For instance, the ability to identify a particular job posting by users may be a service implemented in an independent application server module 204. Similarly, other applications or services that utilize the connection engine 200 may be embodied in their own application server modules 204.

The data layer can include several databases, such as a database 208 for storing connection data 210, such as the indications of interest of job recruiters and job candidates, user characteristics (and/or user preferences), and job profiles, and can further include additional social network information, such as interest groups, companies, advertisements, events, news, discussions, tweets, questions and answers, and so forth. In an example, the connection engine 200 may retrieve a list of job candidates in which a recruiter has indicated an interest, a list of job postings that a particular job candidate has indicated an interest, compare the recruiter list to the job candidate list, and cause a message to be transmitted to the job recruiter and the job candidate if both have indicated an interest.

In various examples, when a person initially registers to become a user (and/or member) of the system 100, the person can be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information can be stored, for example, in the database 208.

The server 104 can include a job poster interface 205, such as with a user interface coupled to the server 104 or via the network interface 106. The job poster interface can include a conventional keyboard and display configuration well known in the art. The job poster interface 205 provides an interface for the posting of jobs, including a corresponding job profile, on the social network.

The job poster interface 205 is coupled to a data management system 206. The data management system 206 can incorporate data management technologies well known in the art or can incorporate proprietary data management structures. In an example, the data management system 206 incorporates SAS, or Statistical Analysis System data management systems, to promote business analysis, statistical analysis, data storage and recovery, and the like for job information. The data management system 206 can include the capacity for social network administrators to utilize the data generated by the data management system 206, such as by inputting tasks into the data management system 206.

The job poster interface 205 and the data management system 206 can both be coupled to the database 208. The job poster interface 205 can transmit job data, such as job profiles, to the database 208 for storage without respect to data management activities. The data management system 206 can store job data in the database 208 upon the job data having been acted upon for data management analysis.

The network interface 106 can provide for the input of user data, such as an indication of a job recruiter's interest in a job candidate or a job candidate's interest in a job posting, into the social network. The user data can be stored in the database 208 or can be directly transmitted to the connection engine 200 for cross reference against the job recruiter's indications and the job applicant's indications. Connections identified by the connection engine 200 can be transmitted via the network interface 106 to the user device 102 for presentation to the job recruiter and the job candidate.

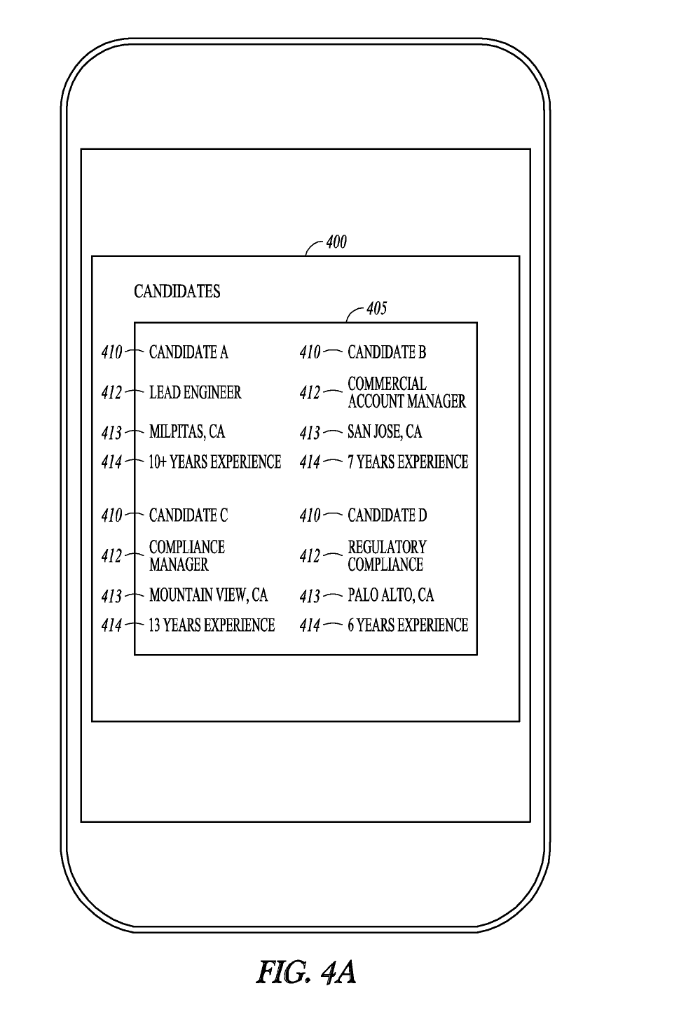

FIG. 3 is a block diagram showing some of the functional components or modules that comprise a connection engine 200, in some examples, and illustrates the flow of data that occurs when performing various operations of a method for connecting job recruiters and job candidates. As illustrated, the connection engine 200 can be coupled to an external data source 310, and can consist of two primary functional modules—an extraction engine 300 and a matching engine 302. The extraction engine 300 can extract indications of a job recruiter or indications of a job applicant, and then the matching engine 302 can perform a matching or connection between job recruiters and job candidates.

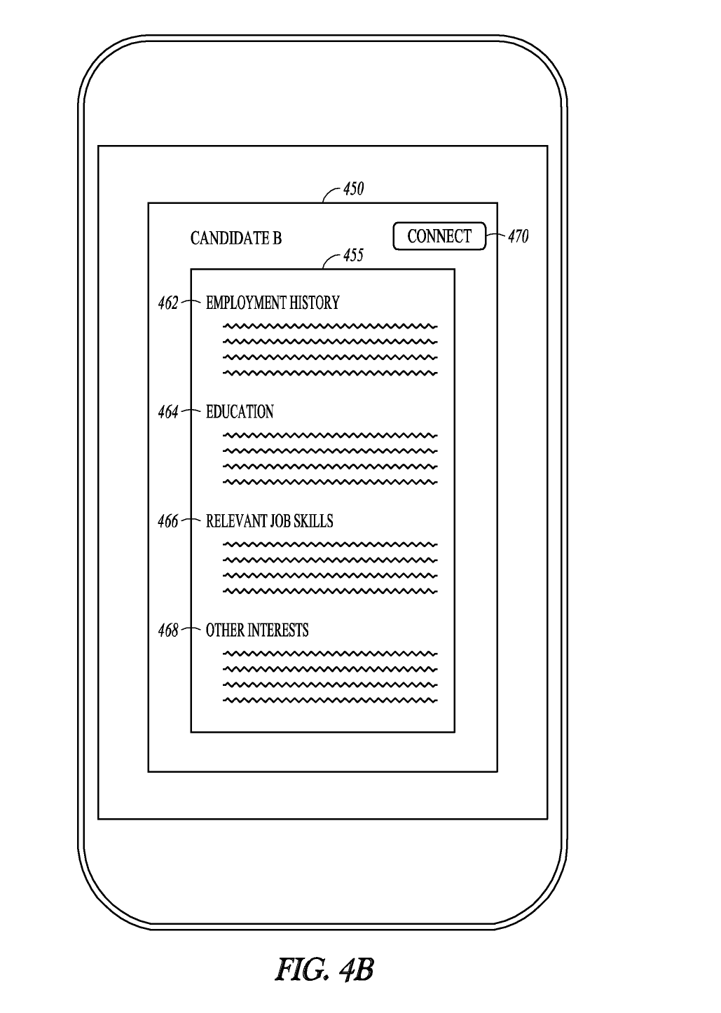

FIGS. 4A and 4B are example user interfaces 400 and 450 that can be displayed by the social network, business network, or job posting service on the recruiter device 102. The user interface screens 400 and 450 can occupy the entire screen of the recruiter device 102. In another example embodiment, the user interface screens 400 and 450 can be a sub-portion of a larger user interface screen displaying additional information related to the social network, business network, or job posting service. The social network server 104 can transmit profiles of job candidates to the recruiter device 102, along with other social network information that is displayed on a user interface of the user device 102.

In the illustrated example of FIG. 4A, the recruiter interface screen 400 includes a list 405 of job candidates 410. For each job candidate 410, the social network server 104 causes the display of the candidate's current job title 412, the candidate's current job location 413, and the job candidate's number of years of experience in the candidate's present job or job field 414. If a recruiter clicks on one of the candidates 410 on the screen 400, the recruiter interface screen 450 is displayed. The recruiter interface screen 450 includes a more detailed profile 455 of the selected candidate that can be reviewed by the recruiter. The candidate profile 455 can include an employment history 462, an education history 464, relevant job skills 466, and other interests and information 468. The user interface 470 includes a connect button 470 that can be used by the recruiter to indicate an interest in the candidate whose profile is displayed on the user interface 450.

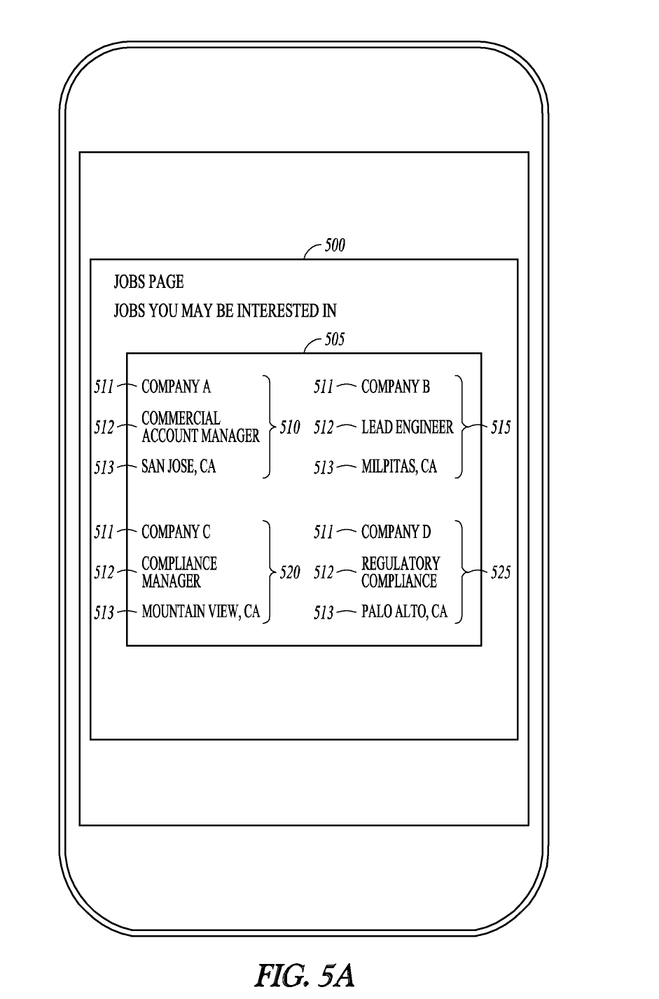

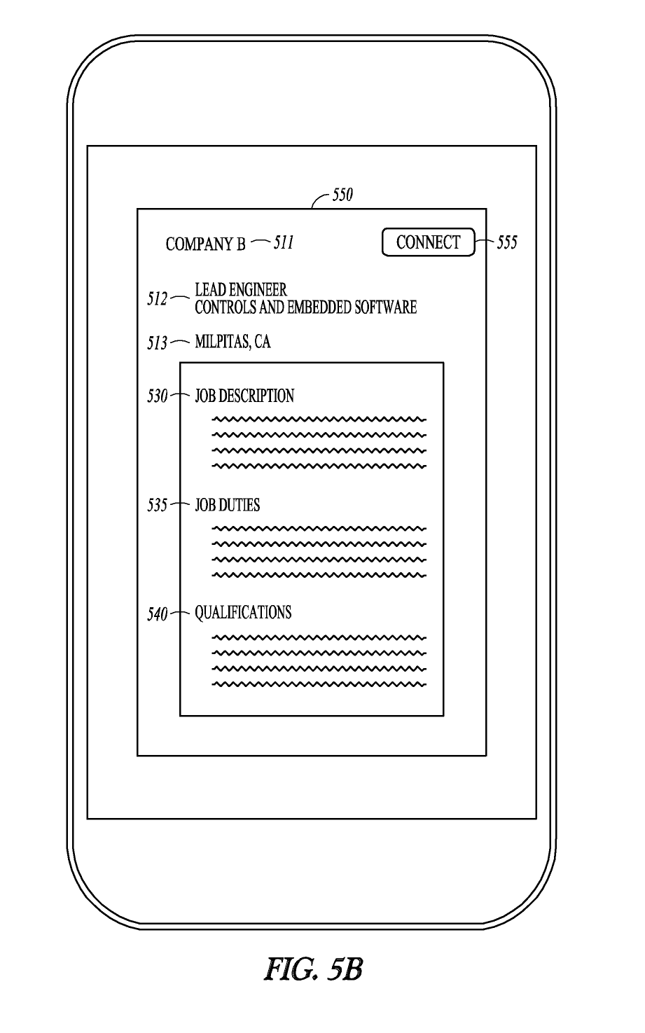

FIGS. 5A and 5B are example user interfaces 500 and 550 that can be displayed on a user device of a job candidate. In the illustrated example, the user interface screen 500 includes a list 505 of jobs 510. In various examples, the list 505 is an ordered list based on various criteria.

In an example, jobs 510, 515 are displayed at the top of the list, i.e., most prominently on the list 505. In the illustrated example, the jobs 510, 515 include a company name 511, a job title 512, and a job location 513.

In the illustrated example, jobs 520, 525 are displayed less prominently than the jobs 510, 515. The jobs 520, 525 also include a company name 511, a job title 512, and a job location 513.

When a job candidate clicks on a job posting displayed on the user interface 500 such as job posting 515, user interface 550 is displayed on the screen of the user device 102. The user interface 550 displays the company name 511, the job title 512, and the job location 513. The user interface further displays a detail job description 530, job duties 535, and job qualifications 540. If the user would like to apply for this job 512 and/or connect with the recruiter who is associated with this job after reviewing the job description 530, job duties 535, and job qualifications 540, the user can click on a connect button 555.

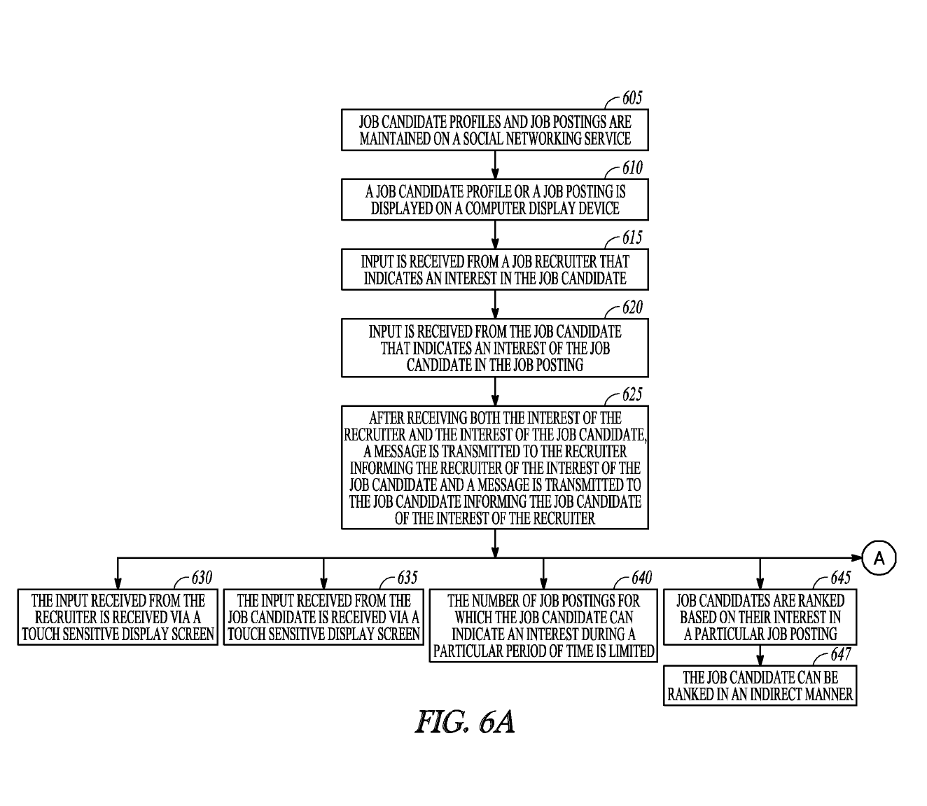

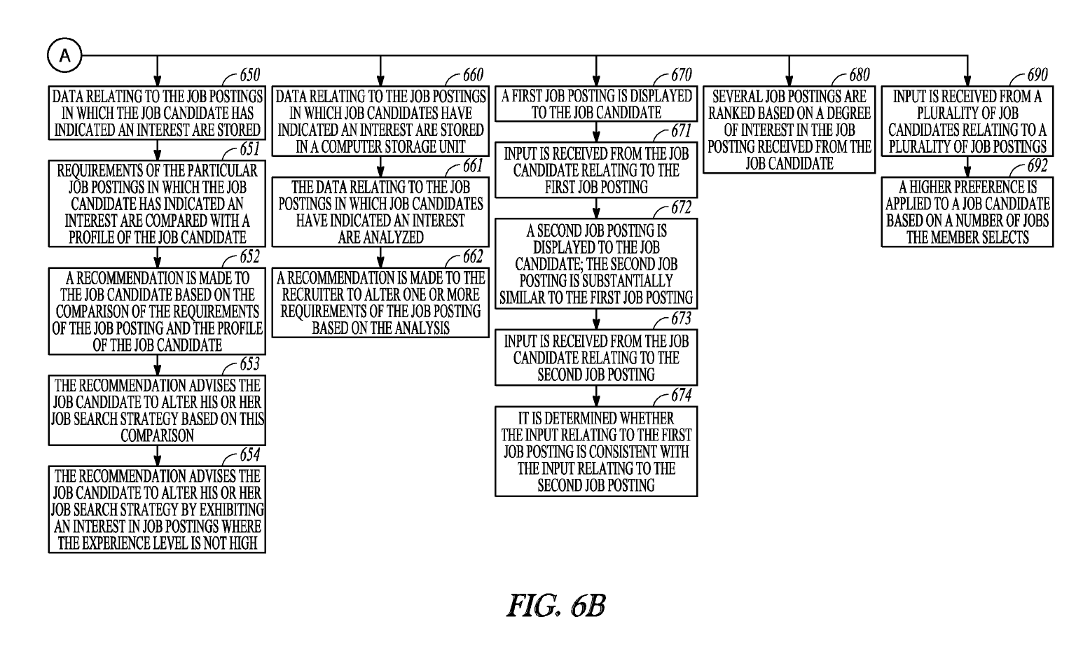

FIGS. 6A and 6B are a block diagram illustrating features of a process and system to assist job recruiters in identifying and communicating with potential job candidates and to assist potential job candidates in identifying potential jobs and communicating with job recruiters who are associated with those potential jobs. In short, FIGS. 6A and 6B illustrate a process and system for job recruiters and job candidates to connect with each other. FIGS. 6A and 6B include a number of process blocks 605-692. Though arranged somewhat serially in the example of FIGS. 6A an 6B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 6A and 6B, at 605, member (or job candidate) profiles and job postings are maintained on a social networking service, a business networking service, and/or a job posting service. The member profiles can include information on the member such as education history, work history, and a list of skills. The job posting can include information on a plurality of job postings such as company name, job title, job description, education requirements, skill requirements, and experience requirements.

At 610, a member profile or a job posting is displayed on a computer display device. The computer device can be a mobile device, and the mobile device can belong to a job recruiter or a job candidate. The job recruiter can be an employee of a particular company that is searching for job candidates, or an independent job recruiter who seeks out attractive job candidates for one or more different companies. At 615, input is received from the job recruiter at his or her mobile device or other computing device that indicates an interest in the job candidate. At 620, input is received from the job candidate at his or her mobile device or other computing device that indicates an interest of the job candidate in the job posting.

At 625, after receiving both the interest of the recruiter and the interest of the job candidate, a message is transmitted to the recruiter informing the recruiter of the interest of the job candidate and a message is transmitted to the job candidate informing the job candidate of the interest of the recruiter. These messages are not transmitted to either the job recruiter or the job candidate until both the job recruiter and the job candidate have respectively indicated an interest in the job candidate and an interest in the particular job posting. The current system is therefore different than the typical scenario wherein a job recruiter first contacts an interesting candidate via telephone, mail, or email even before the job candidate is aware of the particular job. The current system is also different from the typical scenario wherein a job candidate becomes aware of a job posting and contacts the company or job recruiter even before the company or job recruiter has viewed the job candidates resume or profile. Rather, in the current system, both the job recruiter and the job candidate must first indicate an interest in each other, and then and only then are messages transmitted to the job recruiter and the job candidate. In an embodiment, the messages to the job recruiter and the job candidate are transmitted substantially simultaneously. Substantially simultaneously means within the normal time period to electronically transmit two different messages to two different recipients, that is, on the order of only a few seconds or less.

As noted at 630, the input received from the recruiter is received via a touch sensitive display screen. The input can be a pressing of the connect button 470. The input can also be a swipe in a first direction to indicate an interest in the job candidate for a particular job posting or a swipe in a second direction to indicate that the job recruiter has no interest in the job candidate for this particular job posting. This feature is particularly beneficial when the job recruiter is working on a mobile device, and the busy job recruiter can quickly and easily review many job candidates and handle each candidate appropriately. This feature is also very beneficial in a competitive job market wherein highly sought after job postings and job candidates are not on the market for a long period of time before the job posting is filled or the job candidate has made a decision on a new job opportunity.

As noted at 635, the input received from the job candidate can be received via a touch sensitive display screen. The input can be a pressing of the connect button 555. The input can also be a swipe in a first direction to indicate an interest in a particular job posting or a swipe in a second direction to indicate no interest in the particular job posting. This feature is particularly beneficial when the job candidate is working on a mobile device, and the busy job candidate can quickly and easily review several job postings and consider each job posting appropriately. This feature is also very beneficial in a competitive job market wherein highly sought after job postings are posted for only a short period of time before scores of job candidates exhibit an interest and the job posting is filled.

At 640, the number of job postings for which the member or job candidate can indicate an interest during a particular period of time is limited. This feature prevents a job candidate from indicating an interest in virtually any job posting that he or she becomes aware of, in the hopes of landing any first job or any new job. At 645, job candidates are ranked based on their interest in the particular job posting. This ranking can be directly determined or indirectly determined. For example, the ranking can be directly determined by asking the job candidate to rank his or her interest in the particular job. To discourage a job candidate from indicating a high interest in all job postings, a record of the job candidate's rankings of several job postings can be maintained. If the job candidate highly ranks all job postings, the direct rankings by the job candidate can either be ignored or handled in some other appropriate fashion. At 647, the job candidate can be ranked in an indirect manner. For example, a plurality of job candidates who have indicated an interest in the job posting can be inversely ranked. Specifically, a first job candidate who has indicated an interest in fewer job postings can be ranked higher than a second job candidate who has indicated an interest in more job postings. In this manner, more weight is given to the job candidate who has been selective in indicating his or her interest in more than one job posting.

At 650, data relating to the job postings in which the job candidate has indicated an interest are stored. In an embodiment, this data can simply be the indication of the interest in the particular job posting. At 651, requirements of the particular job postings in which the job candidate has indicated an interest are compared with a profile of the job candidate. As indicated above, the profile of a job candidate can include the education history, employment history, and skill set of the job candidate. At 652, a recommendation is made to the job candidate based on the comparison of the requirements of the job posting and the profile of the job candidate, and as indicated at 653, this recommendation can be that the job candidate alter his or her job search strategy based on this comparison. For example, if the comparison indicates that the job candidate is indicating an interest in job postings that require a higher level of experience (by comparing the years of experience in the candidate's profile with the required years of experience in the job posting), then at 654, it can be recommended to the job candidate to alter his or her job search strategy, such as by exhibiting an interest in job postings wherein the experience level is not as high.

In a similar fashion, as indicated at 660, data relating to the job postings in which job candidates have indicated an interest are stored in a computer storage unit. At 661, the data relating to the job postings in which job candidates have indicated an interest are analyzed, and at 662, a recommendation is made to the recruiter that he or she consider altering one or more requirements of the job posting based on the analysis. For example, if the job posting is seeking a candidate who experience in a highly technical and narrow area, and who can speak both Mandarin Chinese and Japanese (because, for example, there are a multitude of Chinese and Japanese business contacts involved in this particular job), the recommendation to the recruiter may be to require only Mandarin Chinese or Japanese, but not both.

In another embodiment, as illustrated at 670, a first job posting is displayed to the job candidate. At 671, input is received from the job candidate relating to the first job posting. At 672, a second job posting is displayed to the job candidate. The second job posting is substantially similar to the first job posting. That is, the education requirements, work history requirements, and skill requirements are substantially similar. At 673, input is received from the job candidate relating to the second job posting. This input can be as simple as the indication of an interest by the job candidate in the job posting. At 674, it is determined whether the input relating to the first job posting is consistent with the input relating to the second job posting. For example, if the job candidate has indicated a high interest in two different job postings that have substantial differences in the job descriptions and/or job requirements, it leads one to question the genuineness of the job candidate's interest, and such indications of interest can be handled accordingly (for example, by ranking another job candidate higher who did not exhibit such potentially conflicting indications).

At 680, several job postings are ranked based on a degree of interest in the job posting received from the job candidate. For example, if the job candidate indicated an interest in five job postings, the job candidate can be required to indicate the posting that is his or her first choice, his or her second choice, etc. This ranking information can be used in an appropriate fashion to determine which job postings should be used to connect with a job recruiter's interest.

At 690, input is received from a plurality of members relating to a plurality of job postings, and at 692, a higher preference is applied to a job candidate based on a number of jobs the member selects. In an embodiment, a higher preference in given to a job candidate who has exhibited an interest in a fewer number of job postings.

Another feature of the present disclosure involves location based matching. Location based matching uses proximity to focus a search beyond what has been outlined above. For example, location can be used in an automatic broad matching feature that is based on the region in which the seeker device is located. For instance, if it is determined that the seeker device is located in San Francisco, the search can be expanded from a localized area to the grater San Francisco area. Another feature relates to automatic fine-grained matching based on the device position. For instance, when a person walks through or is otherwise located in a neighborhood, near-by jobs that match the preferences and skills of that person could be displayed to that person. After that, the normal process of both sides indicating an interest in each other would occur. In this case, the job seeker would be actively seeking jobs and the recruiter would be presented recommendations of the candidate who happened to be in the neighborhood or area. Another feature relates to a more active environment such as a recruiting fair wherein the job seeker is actively looking in some local area, the recruiter is actively looking in the same local area, and they are both presented with good candidates/jobs that are also in the same local area.

Additionally, jobs that are displayed to a job seeker and candidates that are displayed to a recruiter can be calculated as follows. The job seeker or recruiter could do an explicit search. For example, a job seeker could search for job positions using a set of criteria, and a recruiter could search for a job candidate using another set of criteria. As another example, a job could be recommended to a job seeker or a candidate could be recommended to a recruiter based on some automatic matching criteria. As yet another example, a job seeker could be presented with jobs based on the interest of the recruiter and a recruiter could be presented with candidates based on the interest of the job seeker. For instance, if a job seeker indicates an interest, the recruiter could be presented with that job seeker, without specifically indicating the the recruiter was interested.

As noted throughout this disclosure, the system many a times is geared toward very specific jobs. However, in some instances, a recruiter might post a more general job position. For instance, at a recruiting fair, recruiters are normally looking for a general class of people within some parameters. The recruiters may be filling one or more job positions that are described by the same general description. Therefore, the recruiter could post a generic position. Similarly, a fast-food restaurant might post a general hiring positing without detailing the exact details of the position since there may be several responsibilities associated with the position.

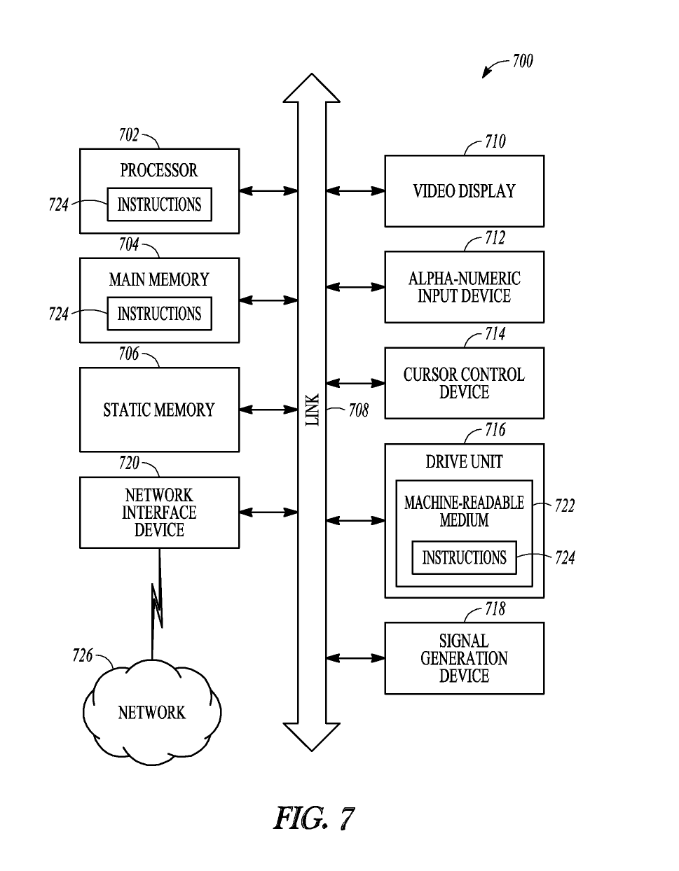

FIG. 7 is a block diagram illustrating components of a machine 700, according to some example examples, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software) for causing the machine 700 to perform any one or more of the methodologies discussed herein may be executed. In alternative examples, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A memory device, the memory device communicatively coupled to a processor and comprising instructions which, when performed on the processor, cause the processor to:
maintain member profiles and job postings on a social networking service;
display a member profile or a job posting on a computer display device;
receive from a job recruiter an indication of an interest in a member for a job posting;
receive from a member an indication of an interest in the job posting; and
after receiving both the interest of the recruiter and the interest of the member, transmit a message to the recruiter informing the recruiter of the interest of the member and transmit a message to the member informing the member of the interest of the recruiter.

2. The memory device of claim 1, comprising instructions to cause the processor to receive the indication from the recruiter via a touch sensitive display screen;
wherein the indication comprises one or more of a swipe in a first direction to indicate an interest in the member and a swipe in a second direction to indicate no interest in the member.

3. The memory device of claim 1, comprising instructions to cause the processor to receive the indication from the member via a touch sensitive display screen;
wherein the indication comprises one or more of a swipe in a first direction to indicate an interest in the job posting and a swipe in a second direction to indicate no interest in the job posting.

4. The memory device of claim 1, comprising instructions to cause the processor to limit a number of job postings for which the member can indicate an interest during a time period.

5. The memory device of claim 1, comprising instructions to cause the computer processor to rank members based on their interest in the job posting.

6. The memory device of claim 5, comprising instructions to cause the computer processor to inversely rank the members indicating an interest in the job posting such that a first member who has indicated an interest in fewer job postings is ranked higher than a second member who has indicated an interest in more job postings.

7. The memory device of claim 1, comprising instructions to cause the computer processor to:
store data relating to the job postings in which the member has indicated an interest;
compare requirements of the job postings in which the member has indicated an interest with a profile of the member; and
make a recommendation to the member based on the comparison of the requirements of the job posting and the profile of the member.

8. The memory device of claim 7, comprising instructions to cause the computer processor to recommend to the member to alter a job search strategy based on the comparison.

9. The memory device of claim 1, comprising instructions to cause the computer processor to:
store data relating to the job postings in which members have indicated an interest;
analyze the data relating to the job postings in which members have indicated an interest; and
recommend to the recruiter that the recruiter consider altering one or more requirements of the job posting based on the analysis.

10. The memory device of claim 1, comprising instructions to cause the computer processor to:
display a first job posting to the member;
receive input from the member relating to the first job posting;
display a second job posting to the member, wherein the second job posting is substantially similar to the first job posting;
receive input from the member relating to the second job posting; and
determine if the input relating to the first job posting is consistent with the input relating to the second job posting.

11. The memory device of claim 1, comprising instructions to cause the computer processor to rank a plurality of job postings based on a degree of interest in the job posting received from the member.

12. The memory device of claim 1, comprising instructions to cause the processor to:
receive input from a plurality of members relating to a plurality of jobs; and
apply a higher preference to a member based on a number of jobs the member selects.

13. A process comprising:
maintaining member profiles and job postings on a social networking service;
displaying a member profile or a job posting on a computer display device;
receiving from a job recruiter an indication of an interest in a member for a job posting;
receiving from a member an indication of an interest in the job posting; and
after receiving both the interest of the recruiter and the interest of the member, transmitting a message to the recruiter informing the recruiter of the interest of the member and transmitting a message to the member informing the member of the interest of the recruiter.

14. The process of claim 13, comprising receiving the indication from the recruiter via a touch sensitive display screen; wherein the indication comprises one or more of a swipe in a first direction to indicate an interest in the member and a swipe in a second direction to indicate no interest in the member.

15. The process of claim 13, comprising receiving the indication from the member via a touch sensitive display screen; wherein the indication comprises one or more of a swipe in a first direction to indicate an interest in the job posting and a swipe in a second direction to indicate no interest in the job posting.

16. The process of claim 13, comprising:
storing data relating to the job postings in which the member has indicated an interest;
comparing requirements of the job postings in which the member has indicated an interest with a profile of the member; and
making a recommendation to the member based on the comparison of the requirements of the job posting and the profile of the member.

17. The process of claim 13, comprising:
storing data relating to the job postings in which members have indicated an interest;
analyzing the data relating to the job postings in which members have indicated an interest; and
recommending to the recruiter that the recruiter consider altering one or more requirements of the job posting based on the analysis.

18. The process of claim 13, comprising:
displaying a first job posting to the member;
receiving input from the member relating to the first job posting;
displaying a second job posting to the member, wherein the second job posting is substantially similar to the first job posting;
receiving input from the member relating to the second job posting; and
determining if the input relating to the first job posting is consistent with the input relating to the second job posting.

19. The process of claim 13, comprising:
receiving input from a plurality of members relating to a plurality of jobs; and
applying a higher preference to a member based on a number of jobs the member selects.

20. A system comprising:
a computer processor configured for:
maintaining member profiles and job postings in an online network environment;
displaying a member profile or a job posting on a computer display device;
receiving from a job recruiter an indication of an interest in a member for a job posting;
receiving from a member an indication of an interest in the job posting; and
after receiving both the interest of the recruiter and the interest of the member, transmitting a message to the recruiter informing the recruiter of the interest of the member and transmitting a message to the member informing the member of the interest of the recruiter.
